(19) United States
(12) Patent Application Publication
(10) Pub. No.: US 2014/0324198 A1
(43) Pub. Date: Oct. 30, 2014

(54) Method for detecting a point of impact on a real moving target

(71) Applicant: Miguel Aubouy, Grenoble (FR)

(72) Inventor: Miguel Aubouy, Grenoble (FR)

(73) Assignee: COMMISSARIAT A L'ENERGIE ATOMIQUE ET AUX ENERGIES ALTERNATIVES, Paris (FR)

(21) Appl. No.: 13/615,957

(22) Filed: Sep. 14, 2012

(30) Foreign Application Priority Data
Sep. 15, 2011 (FR) 1158234

(51) Int. Cl. F41J 5/00; G05B 15/02

(52) U.S. Cl. CPC F41J 5/00; G05B 15/02
USPC 700/90; 702/150

(57) ABSTRACT

A method for detecting an impact point of a projectile or beam fired by a light weapon on a real moving target includes recording a first equation defining a predetermined finished surface capable of covering a target portion that has parameters to be replaced by values that are a function of coordinates of a target point in 3D coordinates, recording a second equation defining, in those coordinates, a projectile or beam trajectory or a cylindrical surface centered thereon, with an electronic sensor partly supported by the target, measuring coordinates of the point on the target based on travel time of electromagnetic waves modulated according to UWB or a magnetic field measured by triaxial magnetic sensors, searching for an intersection between the surface and the trajectory, and depending on whether an intersection is found, indicating existence of an impact point or the absence of such a point.

### RELATED APPLICATIONS

Under 35 USC 119, this application claims the benefit of the priority date of French Patent Application 1158234, filed Sep. 15, 2011, the contents of which are herein incorporated by reference.

### FIELD OF DISCLOSURE

The invention relates to a method for detecting a point of impact of a projectile or of a bean, fired by a light weapon, on a real moving target and a method for protecting a moving target and a method for simulating firing on a real moving target. Further subjects of the invention are a data recording medium, a weapon and an item of target equipment for applying these methods.

### BACKGROUND

The methods for detecting a point of impact on a target are used in many applications including notably the protection of persons or in shooting simulation games.

For example, French patent application FR 2790547 describes such a method for detecting a point of impact on a hunter. In this patent application, the hunter is equipped with an omnidirectional emitter of electromagnetic waves and the weapon is equipped with a directional sensor of these electromagnetic waves. The axis of measurement of the directional sensor is aligned on the axis of the barrel of the weapon. Thus, if the directional sensor detects the electromagnetic waves emitted by the emitter, it means that the hunter is situated in the axis of the barrel and therefore that a shot may cause a point of impact on this hunter. More precisely, the directional sensor detects a point of impact on the hunter when the omnidirectional emitter is inside a detection cone. The vertex of this detection cone is indistinguishable from the weapon and its axis of revolution is indistinguishable from the line of sight of the weapon. The cross section of this detection core increases gradually as it moves away from the weapon in the direction in which the latter points.

However, this method may lead to incorrect detections of points of impact on the hunter or, on the contrary, to the absence of detection of a point of impact on the hunter whereas, if a shot were to be triggered, the hunter would be hit.

For example, when the hunter is at a distance from the weapon, the cross section of the detection cone is much larger than the real cross section occupied by the hunter. This therefore leads to false detections of a point of impact on the hunter.

Conversely, if the hunter is situated very close to the weapon, a portion of his body may be on the axis of the barrel of the weapon while the omnidirectional emitter is outside the detection cone. In these conditions, a point-blank shot could wound the hunter because no point of impact has been detected.

Prior art is also known from: U.S. Pat. No. 4,218,834, and EP1688697

### SUMMARY OF THE INVENTION

The object of the invention is therefore to propose a more effective method of detecting a point of impact on a moving target situated close to the weapon.

In the above methods, the dimensions associated with the target do not necessarily depend on the distance that separates this target from the weapon. Moreover, unlike position sensors using a laser beam which sweeps the environment around the weapon, the use of UWB modulated electromagnetic waves or of a magnetic field makes it possible to precisely locate the point of the target even when the target is close to the weapon. Thus, even if the target is close to the weapon, the point of impact can be detected reliably. In particular, by virtue of this method, it is possible to reliably detect a point-blank shot on the target.

Because of the use of electromagnetic waves or of a magnetic field, it is possible to determine precisely the coordinates of the target even though the target is partly hidden by an object that is transparent to the electromagnetic waves or to the magnetic field. Thus, the portion of the position sensor supported by the target can easily be dissimulated under the clothes of the target, which makes it difficult for the application of the method to be revealed.

The incorrect detection of a point of impact when the target is at a distance is also limited.

These methods also make it possible to detect the point of impact before the shot is triggered.

Finally, these methods can detect points of impact over the whole length of the trajectory of the projectile or of the beam. Thus, this method is applied to both straight shots and to ballistic shots. “Straight shot” means a shot in which the impact with the target occurs on the rectilinear portion of the trajectory collinear with the line of sight. For a straight shot, the effect of gravity is negligible. Conversely, “ballistic shot” means a shot in which the impact with the target occurs on a portion of the trajectory of the projectile in which the latter describes a parabola under the effect of the force of gravity.

The embodiments of this detection method may comprise one or more of the features of the dependent claims.

These embodiments of the detection method also have the following advantages:
measuring the orientation of the target makes it possible to more precisely define the surface S_{C};
using a coordinate system linked with no degree of freedom to the weapon makes it possible to prevent having to measure the direction of the light of sight;
using a coordinate system linked with no degree of freedom to the target makes it possible to prevent having to measure the position of the target.

A further subject of the invention is a method for protecting a real moving target against.

A further subject of the invention is a data recording medium comprising instructions for the execution of one of the above methods, when these instructions are executed by an electronic computer.

A further subject of the invention is a weapon for the application of the above methods.

Finally, a further subject of the invention is an item of target equipment for the application of the above methods.

### BRIEF DESCRIPTION OF THE DRAWINGS

The invention will be better understood on reading the following description given only as a non-limiting example and made with reference to the drawings in which:

FIG. 1 is a schematic illustration of an armament system,

FIG. 2 is a schematic illustration of a first embodiment of a target-protection apparatus applied in the system of FIG. 1,

FIG. 3 is a flowchart of a method for protecting a target applied in the system of FIG. 1,

FIG. 4 is a schematic illustration of a second embodiment of the target-protection apparatus,

FIG. 5 is a flowchart of a method for protecting a moving target with the aid of the apparatus of FIG. 4,

FIG. 6 is a schematic illustration of a third embodiment of the target-protection apparatus,

FIG. 7 is a flowchart of a method for protecting a target with the aid of the apparatus of FIG. 6,

FIG. 8 is a schematic illustration of a firing simulator, and

FIG. 9 is a schematic illustration of a method for operating the simulator of FIG. 8.

In these figures, the same references are used to indicate the same elements.

In the rest of this description, the features and functions that are well known to those skilled in the art are not described in detail.

### DETAILED DESCRIPTION

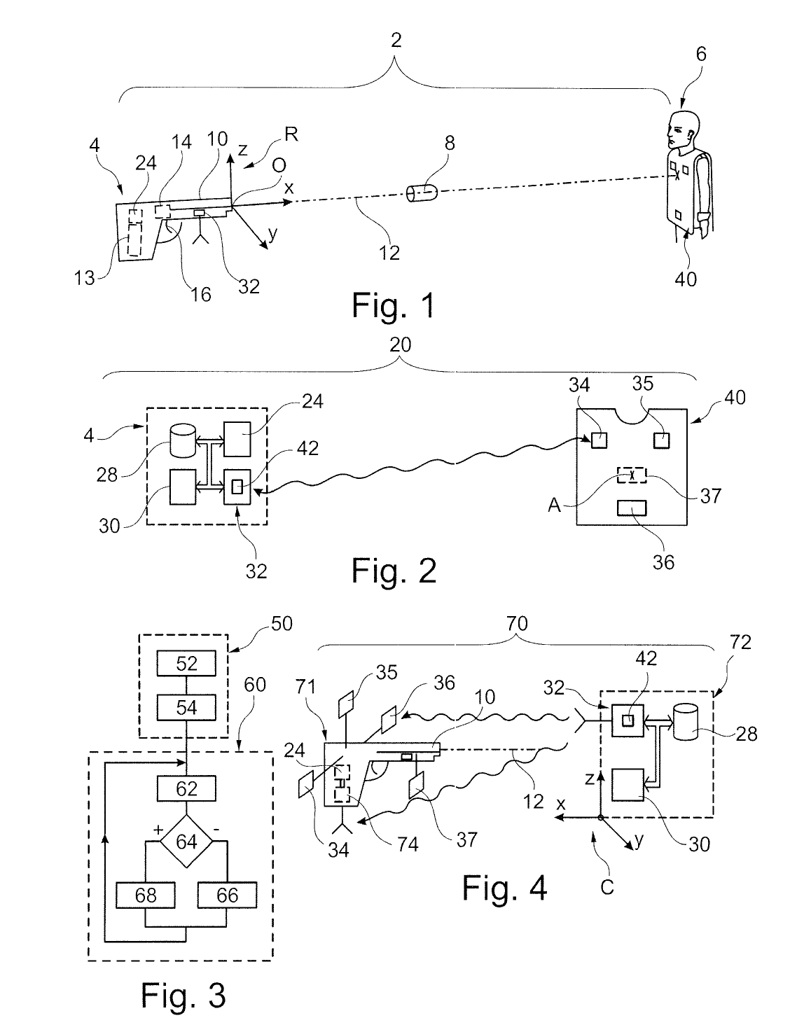

FIG. 1 represents an armament system 2 comprising a weapon 4 capable of firing a projectile or a beam at a real moving target 6.

The projectile or the beam is designed to strike the target at a point called here a point of impact. In this embodiment, the target is a human being and the projectile or the beam is designed to injure this human being at the point of impact. When it is a projectile, the wound is caused by the impact of this projectile on the skin. In the case of a beam, such as a laser beam, the wound is most frequently a burn at the point of impact.

The weapon 4 is a light weapon, that is to say sufficiently light to be able to be carried and used by a single human being with the aid of one or two hands. Typically it is a handgun such as a revolver or a long gun such as a rifle.

The rest of this description is made in the particular case in which the weapon 4 is a handgun and a firearm. In this case, the projectile is a bullet 8 of diameter D.

The weapon 4 comprises:
a barrel 10 which extends along a line of sight 12,
an ammunition magazine 13 containing one or more bullets 8,
a mechanism 14 for firing that is capable of firing a detonating mixture in order to cause an explosion which propels the bullet 8 in the barrel at a subsonic speed, and
a lever 16 which allows the shooter to manually trigger the shot.

The line of sight 12 corresponds to the direction in which the projectile is fired. The direction indicates also the direction in which this projectile is fired.

The firing mechanism 14 is for example capable of generating an electrical discharge which provides the energy necessary to the detonating mixture to trigger its explosion.

The lever 16 is in this instance a human-machine interface secured to the weapon 4 and able to be moved manually by a human being between:
a rest position in which the shot is not triggered, and
a pushed-in position in which it transmits a firing command to the mechanism 14 for immediately triggering the shot.

Typically, the lever takes the form of a mechanical part that can be moved between these two positions by a finger of the shooter.

The system 2 is fitted with an apparatus for protecting the target 6 against the shots from this weapon 4. This apparatus is shown in greater detail in FIG. 2 and is indicated by the reference 20. In this figure, in order to simplify the illustration, the weapon 4 is represented by a square in dashed lines.

The apparatus 20 comprises:
a device for detecting a point of impact on the target 6, and
a mechanism 24 for inhibiting firing that is capable of preventing firing even though the shooter presses on the lever 16.

The device for detecting a point of impact in this instance comprises:
a sensor of the position of a point A of the target 6 in a coordinate system R (FIG. 1) of the weapon 4,
a memory 28,
a programmable electronic computer 30 capable of executing instructions recorded on a data recording medium, that is to say in this instance the memory 28.

The coordinate system R is defined by three axes X, Y, Z that are orthogonal to one another. The axis X is indistinguishable from the line of sight 12 and oriented in the direction of the target. The trajectory of the bullet 8, in the coordinate system R is known in advance. In this instance, the trajectory is fixed and corresponds to the axis X of the coordinate system R. Accordingly, the origin O which is at the intersection of these three axes is fixed with no degree of freedom at the end of the barrel of the weapon 4.

The memory 28 notably contains the instructions and the data necessary for the execution of the method of FIG. 3 by the computer 30.

The position sensor measures the coordinates x_{A}, y_{A} and z_{A} of the point A in the coordinate system R. In this embodiment, it therefore comprises:
a emitter-receiver 32 fixed with no degree of freedom to the weapon 4,
at least four reflectors 34 to 37 fixed with no degree of freedom on a vest 40 worn by the target 6.

The emitter-receiver 32 emits and receives electromagnetic waves modulated according to the UWD (Ultra Wideband) technology. This emitter-receiver comprises a module 42 for computing travelling time. This module 42 measures the time that each electromagnetic wave emitted by this emitter takes to travel the distance between the emitter 32 and each reflector 34 to 37. This module 42 then converts the measured travelling time into a distance dᵢ based on the known speed of propagation of the emitted electromagnetic waves, in which the index i identifies the reflector on which the electromagnetic waves have been reflected. Thus, this module 42 therefore measures four distances d₁ to d₄. The distances d₁ to d₄ correspond respectively to the reflectors 34 to 37. Then, this module 42 converts these distances dᵢ into coordinates of the point A. The point A of which the coordinates are measured is for example the barycentre of the reflectors 34 to 37 computed, for example, with equal weights associated with each reflector.

The reflectors 34 to 37 reflect to the emitter-receiver 32 the electromagnetic waves that are emitted. Three of these reflectors 34 to 36 are placed in one and the same plane and the fourth is placed outside this plane in order to prevent any ambiguity concerning the determination of the position of the target and its orientation. Preferably, the reflectors which are in the same plane are at least 20 or 40 cm away from one another. In this instance, these reflectors 34 to 37 are fixed with no degree of freedom on the vest 40 worn by the target 6. For example, one reflector 34, 35 is placed on each shoulder, another reflector 36 is placed on the stomach and finally a last reflector 37 is placed in the middle of the back when the target 6 is wearing this vest.

The mechanism 24 for inhibiting the firing can be switched by the command of the computer 30 between an active state and a passive state. In the active state, it systematically inhibits the triggering of the shot. In the passive state, the shot can be triggered by pressing on the lever 16.

For example, this mechanism 24 mechanically prevents, in response to an inhibition command, the movement of the lever 16 to its pushed-in position or inhibits the generation of the electrical discharge by the firing mechanism 14 so that even if the lever 16 is in its pushed-in position, the shot is not triggered.

As shown in FIG. 2, the memory 28, the computer 30 and the emitter-receiver 32 are fixed to the weapon 4. More precisely, they are received inside a housing arranged in the weapon 4 and enclosed by a cover that is resistant to any attempt to tear off with the hands or with the aid of a pincer. Preferably, this cover is closed by screws having a head which does not fit the tip of a standard screwdriver.

The operation of the apparatus 20 will now be described in greater detail with reference to the method of FIG. 3.

This method begins with an initialization phase 50. This phase 50 begins with a step 52 of recording in the memory 28 an equation of a cylinder S_{D} which extends from the end of the barrel 10 to infinity along the line of sight 12. Here, the cylinder S_{D} is a cylinder of revolution with a radius rₚ. The radius rₚ is between D/2 and β*D/2, where D is the diameter of the bullet 8 and β is a constant that is strictly greater than 1 and less than 100, 10 or 3. For example, the radius rₚ is in this instance between 1 and 10 cm. In this instance, it is taken to be equal to 5 cm. The equation of the cylinder S_{D} in the coordinate system R is for example given by the following relation:

y²+z²=rₚ² and x≧0 (1)

During a step 54, an equation defining a surface S_{C} is recorded in the memory 28. The surface S_{C} is associated in the memory 28 with the point A. More precisely, the position of this surface S_{C} in the coordinate system R is defined by the position of the point A. In this instance, this surface S_{C} delimits a volume which encompasses the point A. In this particular embodiment, it also encompasses the majority of the volume of the target 6. For example, the surface S_{C} is a sphere centered on the point A of radius r_{c}. Typically, in this embodiment, the radius r_{c} is greater than 50 cm or 1 m.

The equation of the surface S_{C} contains parameters designed to be replaced by values that are a function of the coordinates x_{A}, y_{A}, z_{A} measured from the point A. In this instance, these parameters are equal, respectively, to the coordinates x_{A}, y_{A}, z_{A}. They are therefore also marked x_{A}, y_{A}, z_{A}. Preferably, the surface S_{C} is independent of the distance that separates the point A from the weapon 4. For example, the equation of the surface S_{C} is as follows:

(x−x_{A})²+(y−y_{A})²+(z−z_{A})²=r_{c}² (2)

The radius r_{c} defining the surface S_{C} is also recorded in the memory 28 during this initialization phase.

Once this apparatus 20 is initialized, it is then possible to proceed to a usage phase 60. During a step 62, the position sensor constantly measures the coordinates x_{A}, y_{A}, z_{A} of the point A in the coordinate system R. For this, the emitter-receiver 32 emits electromagnetic waves that are reflected by the reflectors 34 to 37. The module 42 measures the travelling time between the emitter 32 and these reflectors 34 to 37 and deduces therefrom the distances d₁ to d₄. Based on these distances d₁ to d₄, it computes the coordinates x_{A}, y_{A}, z_{A} of the point A in the coordinate system R.

During a step 64, the computer 30 acquires the coordinates measured by the position sensor and then seeks to ascertain whether there is at least one point of intersection between the surfaces S_{D} and S_{C}. For this, the computer 30 replaces the parameters x_{A}, y_{A}, z_{A} in the equation (2) with the measured values of these parameters during the step 62 in order to thus obtain a configured equation.

Then, it seeks a solution to the system of equations formed by the combination of the equation (1) and the equation (2) configured with the coordinates x_{A}, y_{A}, z_{A}. This system of equations can accept a single point of intersection, an infinity of points of intersection or no point of intersection.

If no point of intersection has been found, during a step 66, the computer 30 controls the mechanism 24 in order to make it switch to the inactive state. Thus, the weapon 4 remains usable against any object other than the target 6.

If, on the other hand, at least one point of intersection between the surfaces S_{D} and S_{C} has been found, during a step 68, the computer 30 controls the mechanism 24 in order to make it immediately switch to the active state. Thus, when the weapon 4 is pointed at the target 6, no shot from this weapon 4 at the target 6 can be triggered. The target is therefore effectively protected.

Such a protective apparatus is particularly effective for preventing a weapon stolen for example from a guard to be used against him.

FIG. 4 represents an apparatus 70 for protecting the target 6 against the shots from a weapon 71. This apparatus 70 is identical to the apparatus 20 except that:
the computer 30, the emitter-receiver 32 and the memory 28 are located in a housing 72 worn by the target 6,
the four reflectors 34 to 37 are fixed with no degree of freedom to the weapon 4.

Here, the reflectors 34 to 36 are fixed in a plane perpendicular to the line of sight 12 and the reflector 37 is situated in front of this plane in the direction in which the weapon is pointed.

The weapon 71 also comprises an emitter-receiver 74 connected to the firing inhibition mechanism 24.

In this embodiment, the combination of the reflectors 34 to 37 and of the emitter-receiver 32 forms a sensor of the coordinates of the weapon 71 and of the direction of the line of sight 12 in a coordinate system C fixed with no degree of freedom to the housing 72. Since four reflectors are used, the direction in which the weapon 71 points is measured.

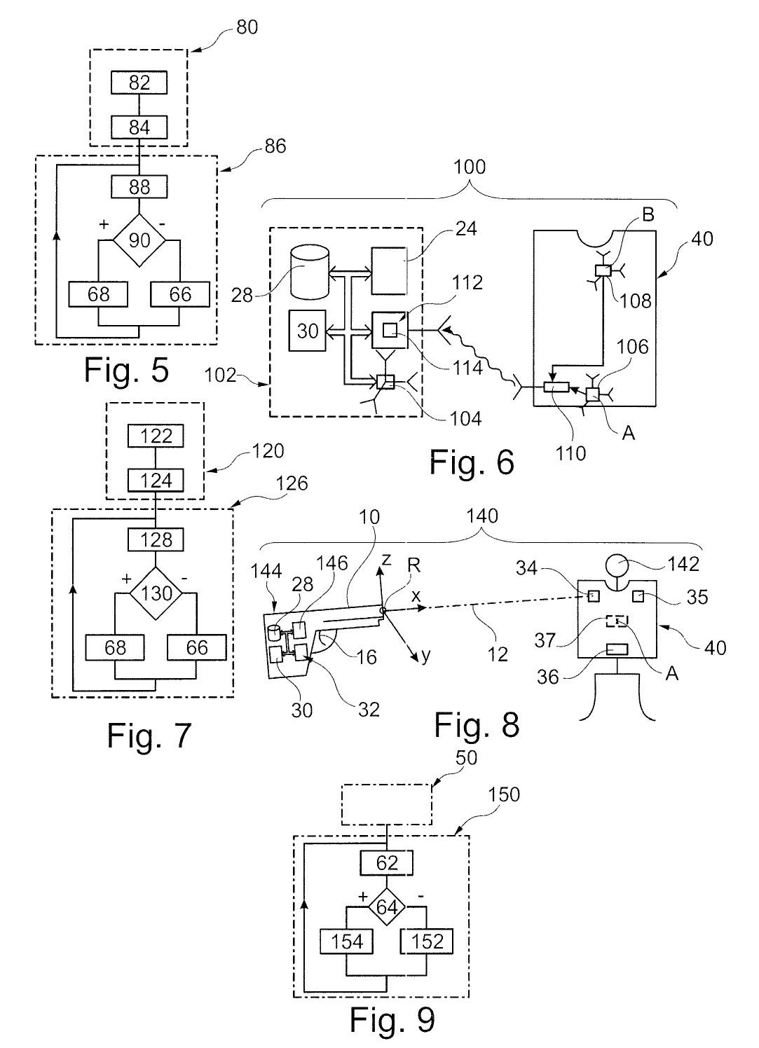

The operation of the apparatus 70 will now be described in greater detail with reference to the method of FIG. 5. The method of FIG. 5 begins with an initialization phase 80. This phase 80 is similar to the phase 50 and also comprises two steps 82 and 84. The step 82 is identical to the step 52 except that the recorded equation of the cylinder S_{D} contains parameters designed to be replaced by the orientation of the line of sight 12. For example, the orientation of the line of sight is given by parameters θₓ, θ_{y} and θ_{z} giving the inclination of this line of sight relative, respectively, to the axes X, Y and Z of the coordinate system C. The equation of the cylinder S_{D} also comprises parameters designed to be replaced by the coordinates xₘ, yₘ and zₘ of the weapon 71 in the coordinate system C.

Step 84 is identical to the step 54 except that the recorded equation of the surface S_{C} does not contain the parameters x_{A}, y_{A}, z_{A} designed to be replaced by the measured position of the target. Specifically, in this embodiment, the position of the target in the coordinate system C is known in advance. Here this position is fixed.

Once the initialization phase is completed, there follows a phase 86 of use of the apparatus 70. During a step 88, the position of the end of the barrel 10 and the orientation of the line of sight 12 are measured with the aid of the emitter-receiver 32 and of the reflectors 34 to 37.

During a step 90, the computer 30 acquires the measured values of the parameters xₘ, yₘ, zₘ and θₓ, θ_{y} and θ_{z} and then searches to ascertain whether there is a point of intersection between the surfaces S_{D} and S_{C}. For this, it replaces the parameters xₘ, yₘ, zₘ and the parameters θₓ, θ_{y} and θ_{z} with the values measured during the step 88 in order to obtain a configured equation of the surface S_{D}. Then, the computer 30 seeks to ascertain whether there is at least one solution to the system of equations formed by the equation of the surface S_{C} and the configured equation of the surface S_{D}. If there is no point of intersection, it proceeds to the step 66. In the contrary case, it proceeds to the step 68. These steps have been described above with respect to FIG. 3. However, in this instance, during the step 68, the instruction to inhibit the mechanism 24 is received via the emitter-receiver 74.

FIG. 6 represents an apparatus 100 for protecting the target 6 against the shots from a weapon 102. This apparatus 100 is identical to the apparatus 20 except that the sensor of the position of the target 6 in the coordinate system R is achieved differently.

More precisely, a triaxial magnetic source 104 is housed inside the weapon 102. This source 104 is a source that emits magnetic fields in three emission directions that are not parallel with one another and that intersect at a central point. Here, these directions of emission are orthogonal to one another, and, for example, parallel respectively with the axes X, Y and Z of the coordinate system R. Typically, this source 104 is produced with the aid of coils wound respectively about each of the emission axes.

The reflectors 34 to 37 are replaced by one or more triaxial magnetic sensors. Here, two triaxial magnetic sensors 106 and 108 are used. They are respectively placed at points A and B of the target 6. Here, the point A is close to the stomach of the target and the point B is close to the neck of the target when the vest 40 to which these sensors 106 and 108 are fixed is worn by the target 6.

Each sensor 106, 108 comprises at least three measurement axes that are not parallel with one another. More precisely, each sensor measures the orthogonal projection of the magnetic field on each of its measurement axes. Thus each sensor is capable of measuring the direction and the amplitude of the magnetic field emitted by the source 104. Accordingly, like the source 104, each sensor usually comprises coils each wound about a respective measurement axis.

These sensors 106 and 108 are connected to an emitter-receiver 110 which transmits the measurements taken by the sensors 106 and 108 to an emitter-receiver 112 housed inside the weapon 102. The emitter-receiver 110 is also worn by the target 6. For example, it is fixed with no degree of freedom to the vest 40 like the sensors 106 and 108.

The emitter-receiver 112 in this instance replaces the emitter-receiver 32 of the apparatus 20. This emitter-receiver 112 also makes it possible to synchronize the operation of the sensors 106 and 108 with the operation of the source 104.

The emitter-receiver 112 also comprises a module 114 for computing the position and the orientation of the points A and B in the coordinate system R based on:
the received measurements of the sensors 106 and 108,
the direction and the amplitude of the magnetic field emitted by the source 104, and
a mathematical model connecting the measurements of each sensor 106, 108 to the magnetic field emitted by the source 104.

The operation of the apparatus 100 will now be described in greater detail with reference to the method of FIG. 7.

This method begins with an initialization phase 120. This phase 120 comprises two steps 122 and 124. The step 122 is identical to the step 52 of recording the equation of the surface S_{D}. The step 124 is identical to the step 54 except that two equations each defining one surface, respectively S_{C1} and S_{C2}, are recorded in the memory 28. The first equation defining the surface S_{C1} is associated with the points A and B. The second equation defining the surface S_{C2} is associated with the point B. These first and second equations each comprise parameters designed to be replaced oy the values, respectively, of the coordinates x_{A}, y_{A}, z_{A}, x_{B}, y_{B}, z_{B} of the points A and B and the coordinates x_{B}, y_{B}, z_{B} of the point B.

For example, the surface S_{C1} is a cylinder of revolution limited by two parallel planes orthogonal to its axis of revolution. The axis of revolution in this instance passes through the points A and B. The point A is situated halfway between these two planes. The radius of this cylinder is typically between 20 cm and 1 m and preferably between 20 cm and 60 cm. The height of this cylinder is between for example 1.40 m and 1.80 m so as to encompass the target 6.

The surface S_{C2} is a sphere centered on the point B of which the radius is between 30 cm and 1 m, for example.

After having been initialized, the method continues with a phase 126 of use. During a step 128, the position of the points A and B is measured with the aid of the sensors 106 and 108, the source 104 and the module 114. The position of the points A and B in the coordinate system R is determined in conventional manner. For example, such determination methods are described in patent application EP 1 502 544 or in the patent filed under No FR 09 57 205.

Then, during a step 130, the computer 30 acquires the measurements of the position of the points A and B. In this embodiment, the orientation of the target is deduced from the positions measured for the points A and B. During this step 130, this computer also searches for the existence of a point of intersection between the surface S_{D} and the surface S_{C1} or the surface S_{C2}. This step 130 is for example identical to the step 64 except that the step 64 is reiterated twice: a first time in order to determine the points of intersection between the surface S_{D} and the configured surface S_{C1}, then a second time in order to determine the existence of points of intersection between the surface S_{D} and the configured surface S_{C2}.

As described above, during the step 130, the parameters of the equations of the surfaces S_{C1} and S_{C2} are replaced by the values measured during the step 128.

Then, if no point of intersection has been found, the method continues with the step 66 and, in the contrary case, with the step 68.

FIG. 8 represents a simulator 140 of firing on a moving target 142 with the aid of a dummy weapon 144. The weapon 144 is incapable of firing a projectile or a beam capable of wounding the target 142 when the target 142 is a human being. For example, accordingly, the weapon 144 has no firing mechanism. In this embodiment, the weapon 144 is identical to the weapon 4 except that the firing mechanism 16 is omitted. In particular, this weapon 144 has all of the elements necessary for detecting a point of impact on the target 142.

Thus, the mechanism 24 for inhibiting firing is replaced by a human-machine interface 146 in order to indicate to the shooter whether the target has been hit and, if necessary, other information depending on the detected point of impact.

The operation of the simulator 140 will now be described in greater detail with reference tc the method of FIG. 9. This method begins with an initialization phase identical to the phase 50.

Then, it continues with a phase 150 of use of the simulator 140. This phase 150 is identical to the phase 60 except that the steps 66 and 68 are replaced respectively by steps 152 and 154. Moreover, step 64 is triggered only when the shooter presses on the lever 16.

If no point of impact has been detected, during the step 52, this information is communicated to the shooter via the human-machine interface 146. For example, a visual signal or an audible signal tells him that the target 142 has been missed. This information may also be communicated to the shooter by the absence of any information, relating to the existence of a point of impact, transmitted via the human-machine interface 146.

When the existence of at least one point of impact has been found, during the step 154, the human-machine interface 146 tells the shooter that the target has been hit. Moreover, the human-machine interface may also indicate a number of corresponding points. Typically, the number of points varies as a function of the surface S_{C} that has been hit and, preferably, as a function of the position of the point of impact on this surface. For example, a greater number of points is associated with a shot of which the trajectory travels to the centre or close to the centre of the surface S_{C}, while a lesser number of points is associated with a shot of which the trajectory traverses the surface S_{C} but at a distance far from its centre.

Many other embodiments are possible. For example, the weapon may be an automatic weapon, a semi-automatic weapon, or a single-shot weapon. The weapon can fire projectiles or a beam such as a laser beam.

The firing mechanism can be produced differently. For example, it can be produced with the aid of a firing pin in order to trigger the explosion of the detonating mixture in response to an impact.

The position sensor may be produced differently. For example, more than four reflectors can be used. The reflectors can also be replaced by emitters of electromagnetic waves received by the emitter-receiver 32 housed in the weapon. In this case, preferably, the four emitters emit four different electromagnetic waves at the same time so that the module for computing the travelling time can identify each emitter. The timing synchronization between the emitters and the receiver is for example achieved with the aid of a particular encoding of the electromagnetic waves that are emitted.

The target is not necessarily a human being. It may, for example, be a vehicle or another moving object fitted with the elements necessary for detecting a point of impact on this object.

There may also be several targets mechanically independent of one another on which it is necessary to detect a point of impact. In this case, for example, what has been described above is carried out for each of these targets.

In response to the detection of a point of impact, actions other than those previously illustrated can be initiated. For example, the weapon is fitted with an alarm suitable for generating a sound that can be directly perceived by the shooter when it is triggered. This alarm is triggered in response to the detection of a point of impact.

Conversely, if it is desired to limit the collateral damage caused by a weapon, the firing inhibition mechanism is by default in the active state except when a point of impact is detected on the target.

The coordinate system in which the position is measured is not necessarily associated with the weapon or with the target. In the case of a coordinate system that is mechanically independent of the weapon and of the target, a sensor of the position of the target in this coordinate system and a sensor of position and of orientation of the line of sight in this coordinate system are provided.

The surface S_{C} may take all appropriate forms to protect the target. In particular, the surface S_{C} does not necessarily delimit a volume. For example, the surface S_{C} may be a plane behind which the target is hidden.

This surface S_{C} is not necessarily constant. For example, this surface may be modified depending on the distance that separates several points fixed on the target and the positions of which are measured.

The point or points of the target of which the positions are measured are not necessarily covered by the surface S_{C}. For example, the height of the cylinder defined on the basis of the positions of the points A and B in the embodiment of FIG. 6 can be less than the distance that separates these points A and B.

The surface S_{C} may be associated with one or more points of the target. For example, if the surface S_{C} is an ellipse, it is preferably associated with two points of the target and the equation of this surface is configured with the coordinates measured for these two points.

The methods described above apply equally to the case in which the positions of N points of the target are measured, where N is an integer greater than two or six. For example, the position of each of these points is useful for defining one or more surfaces S_{Cj}, where the index j identifies a surface covering all or some of the target.

In a simplified variant, the surface S_{D} is replaced by a simple trajectory. In other variants, other forms of a cylinder of revolution are used such as for example a cylinder of which the cross section is rectangular.

It is also possible to have several surfaces S_{cj} fitted inside one another, where the index j identifies a surface covering all or some of the target. In this case, when an intersection only with the largest surface is found, a signal alerts the shooter. Conversely, if an intersection with the smallest surface is found, the firing inhibition is automatically activated. This makes it possible notably to install a graduation in the alarm. Preferably, the equations of the surfaces S_{cj} are configured on the basis of the same measured position of the target.

Preferably, the surfaces S_{D} and S_{C} are independent of the distance that separates the target from the weapon.

The search for a point of intersection may also be implemented on the side of the target.

The search may also be speeded up by virtue of approximations. For example, it is not necessary to find all the points of intersection but only one point of intersection with the surface S_{C}. It is also possible to search for the points of intersection between the volumes delimited by the surfaces S_{C} and S_{D}.

The equations and notably that of the surface S_{D} may comprise additional parameters. For example, the equation of the surface S_{D} may comprise additional parameters designed to be replaced by values that are a function of the direction of the field of Earth's gravity. In order to replace these parameters with values, the weapon is for example fitted with an accelerometer which measures the inclination of the line of sight relative to a plane perpendicular to the force of gravity. Such a variant makes it possible to apply what has been described above to the case of ballistic trajectories. In the case of a ballistic trajectory, the generatrix of the cylinder is not a straight line. In this description, a cylinder is defined by the movement of a flat figure centered on the trajectory and contained, at any point of the trajectory, in a plane perpendicular at the tangent at this point to the trajectory. For example, the flat figure is a circle.

1-12. (canceled)

13. A method for detecting a point of impact of one of a projectile and a beam fired by a light weapon on a real moving target, said light weapon being a weapon that can be carried and used by a single human being, said method comprising recording a first equation defining a predetermined finished surface capable of covering a portion of said target, said first equation containing parameters that are to be replaced by values that are a function of coordinates of a point on said target in a three-dimensional coordinate system, recording a second equation defining, in said coordinate system, one of a trajectory of said one of a projectile and beam fired by said light weapon and a cylindrical surface centered on said trajectory, with the aid of an electronic sensor comprising at least one portion supported by said target, measuring coordinates of said point on said target in said coordinate system based on one of travel time of electromagnetic waves modulated according to ultra wideband technology and on measurement of a magnetic field by one or more tri-axial magnetic sensors, searching for a point of intersection between one of said predetermined finished surface and said trajectory, and between one of said predetermined finished surface and said cylindrical surface by using said second recorded equation and said first recorded equation in which said parameters are replaced by values that are a function of said measured coordinates of said point of said target, and if at least one point of intersection is found, indicating an existence of a point of impact, and if no point of intersection is found, indicating an absence of a point of impact.

14. The method of claim 13, wherein said first equation comprises second parameters to be replaced by values that are a function of an orientation of said target in said coordinate system, and wherein said method further comprises using an electronic sensor of which at least one portion is supported by said target, measuring said orientation of said target, and while searching for a point of intersection, replacing said second parameters of said first equation by values that are a function of said measured orientation of said target.

15. The method of claim 13, wherein said coordinate system is linked, with no degree of freedom, to said light weapon.

16. The method of claim 13, wherein said recited steps are repeated for at least two different points on said target.

17. A method for detecting a point of impact of one of a projectile and a beam, said one of a projectile and a beam being fired by a light weapon on a real moving target, said light weapon being a weapon that can be carried and used by a single human being, said method comprising recording a first equation defining a predetermined finished surface capable of covering at least one portion of said target in a three-dimensional coordinate system, recording a second equation defining, in said coordinate system, one of a trajectory of one of said projectile and said beam fired by said light weapon, and a cylinder centered on said trajectory, said second equation comprising first parameters to be replaced by values that are a function of a position of said light weapon, and second parameters to be replaced by values that are a function of a direction of a line-of-sight of said light weapon, using an electronic sensor comprising at least one portion supported by said target, measuring said position of said light weapon and said direction of said line-of-sight of said light weapon in said three-dimensional coordinate system based at least in part on one of a travel time of electromagnetic waves modulated according to UWD technology and measurement of a magnetic field by at least one tri-axial magnetic sensor, using said first equation and said second equation in which said first and second parameters are replaced by values that are a function respectively of said measured position and said measured direction, searching for a point of intersection between one of said predetermined finished surface and said trajectory of one of said projectile and said beam, and said predetermined finished surface and said cylinder centered on said trajectory, if a point of intersection is found, indicating existence of a point of impact, and if no point of intersection is found, indicating absence of a point of impact.

18. The method of claim 17, wherein said coordinate system is linked, with no degree of freedom, to said target.

19. The method of claim 17, wherein said recited steps are repeated for at least two different points on said target.

20. A method for protecting a real moving target against shots, said method comprising detecting a point of impact of one of a projectile and a beam capable of being fired by a light weapon at said target before triggering a shot, said light weapon being a weapon that can be carried and used by a single human being, in response to detecting said point of impact, systematically inhibiting firing of said light weapon and, if no impact is detected, refraining from systematically inhibiting firing of said light weapon, wherein detecting comprises executing the method recited in claim 13.

21. A method for simulating firing on a real moving target, said method comprising detecting a point of impact of one of a projectile and a simulated beam fired by a light weapon at a moment of triggering of a shot, said light weapon being a weapon configured to be carried and used by a single human being, and in response to detecting a point of impact, indicating to a shooter, via a human-machine interface, that said shot has hit said target, and in absence of detecting a point of impact, refraining from indicating, to the shooter, existence of a point of impact on said target, wherein detecting comprises executing the method recited in claim 13.

22. A manufacture comprising a tangible and non-transitory data recording medium comprising instructions for causing the method of claim 13 to be executed by an electronic computer.

23. An apparatus comprising a light weapon for application of the method recited in claim 13, said light weapon comprising a memory comprising said first equation and said second equation recorded therein, and an electronic computer programmed to acquire measured coordinates of said point on said target, to search for said point of intersection, and to indicate existence of a point of impact if at least one point of intersection is found, and, in the absence of finding at least one point of intersection, to indicate absence of a point of impact.

24. An apparatus comprising target equipment for the application of the method recited in claim 16, wherein said target equipment comprises a memory comprising said first equation and said second equation recorded therein, and an electronic computer programmed to acquire a position of said light weapon and the direction of a line-of-sight thereof, to search for a point of intersection between one of said predetermined finished surface and the trajectory of one of said projectile of and said beam and between said predetermined finished surface and a cylinder centered on said trajectory, by using the first equation and the second equation in which the first and second parameters are replaced by values that are a function, respectively, of the acquired position and direction, and to indicate existence of a point of impact if at least one point of intersection is found, and, to indicate the absence of a point of impact if no point of intersection is found.
